(19) United States
(12) Patent Application Publication
(10) Pub. No.: US 2023/0084627 A1
(43) Pub. Date: Mar. 16, 2023

(54) LIQUID COLLECTION CONTAINER

(71) Applicant: Foy Real, Dallas, TX (US)

(72) Inventor: Foy Real, Dallas, TX (US)

(21) Appl. No.: 17/477,097

(22) Filed: Sep. 16, 2021

(51) Int. Cl. F24F 13/22; E03B 3/28; C02F 1/00; C02F 1/28; C02F 1/44

(52) U.S. Cl. CPC F24F 13/222; E03B 3/28; C02F 1/001; C02F 1/283; C02F 1/441; F24F 2013/227; C02F 2103/18

(57) ABSTRACT

A liquid collection container removably connected to an air conditioning unit, the liquid collection container including a main body to store at least one liquid therein, a primary hose removably connected to at least a portion of the main body to direct the at least one liquid condensed from the air conditioning unit into the main body, and a pump disposed within at least a portion of the main body to extract the at least one liquid from within the main body and expel the at least one liquid from the main body.

### BACKGROUND

### 1. Field

The present general inventive concept relates generally to water collection, and particularly, to a liquid collection container.

### 2. Description of the Related Art

In some areas of the world, spring and/or summer seasons bring warmer temperatures. Moreover, the spring and/or the summer seasons are often associated with an increase in humidity. The increase in the temperature and/or the humidity is often uncomfortable for most people. As such, most people tend to operate an air conditioning unit indoors to make the indoor environment more comfortable.

However, prolonged use of the air conditioning unit results in accumulation of condensation both on an exterior and/or within an interior the air conditioning unit. The water from the condensation is usually left unused, which is wasted because it is usually left to evaporate.

Therefore, there is a need for a liquid collection container that connects to the air conditioning unit and stores the water from condensation for other uses.

### SUMMARY

The present general inventive concept provides a liquid collection container.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a liquid collection container removably connected to an air conditioning unit, the liquid collection container including a main body to store at least one liquid therein, a primary hose removably connected to at least a portion of the main body to direct the at least one liquid condensed from the air conditioning unit into the main body, and a pump disposed within at least a portion of the main body to extract the at least one liquid from within the main body and expel the at least one liquid from the main body.

The primary hose may include a filtration unit to cleanse the at least one liquid moving therethrough.

The filtration unit may be at least one of a sediment filter, a carbon filter, and a reverse osmosis unit.

The liquid collection container may further include a connector hose removably connected to at least a portion of the air conditioning unit and the primary hose to transfer condensation from the air conditioning unit into the primary hose.

The liquid collection container may further include an atmospheric water generator removably connected to the air conditioning unit to extract water from humidity in the air conditioning unit and transfer the water to the primary hose.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a liquid collection container, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Liquid Collection Container 100
Main Body 110
Insulated Housing 111
Cap 112
Liquid Outlet 113
Primary Hose 120
Filtration Unit 121
Connector Hose 130
Pump 140
Switch 141
Atmospheric Water Generator 150
Extraction Hose 151
Power Source 160

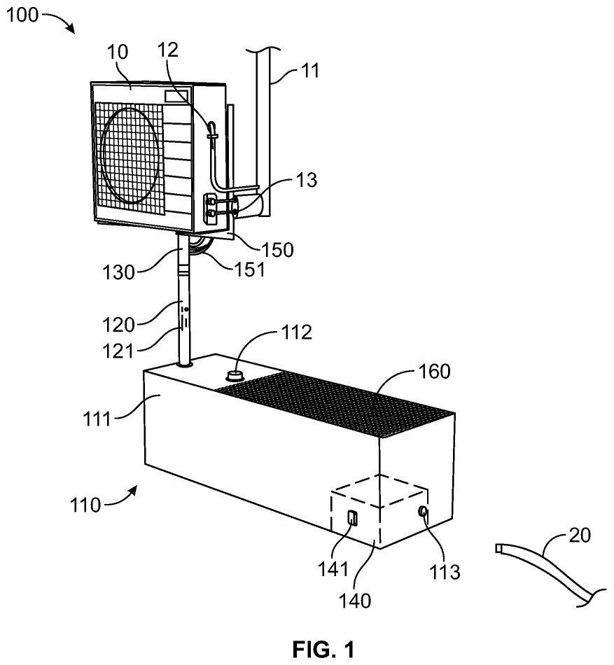

FIG. 1 illustrates a side perspective view of a liquid collection container 100, according to an exemplary embodiment of the present general inventive concept.

The liquid collection container 100 may be constructed from at least one of metal, plastic, wood, glass, and rubber, etc., but is not limited thereto.

The liquid collection container 100 may include a main body 110, a primary hose 120, a connector hose 130, a pump 140, an atmospheric water generator 150, and a power source 160, but is not limited thereto.

Referring to FIG. 1, the main body 110 is illustrated to have a rectangular prism shape. However, the main body 110 may be rectangular, circular, conical, triangular, pentagonal, hexagonal, heptagonal, octagonal, or any other shape known to one of ordinary skill in the art, but is not limited thereto.

The main body 110 may store at least one liquid therein.

The main body 110 may include an insulated housing 111, a cap 112, and a liquid outlet 113, but is not limited thereto.

The insulated housing 111 may be constructed of aluminum, ceramic, polyethylene terephthalate (PET), closed-cell extruded polystyrene foam, polyurethane, polypropylene, and/or refrigerant gel, but is not limited thereto.

The insulated housing 111 may be disposed within at least a portion of an interior and/or at least a portion of an exterior of the main body 110. The insulated housing 111 may insulate the main body 110 to retain cool air within the main body 110, such that the insulated housing 111 may prevent a temperature level within the main body 110 from increasing. As such, the insulated housing 111 may prevent the at least one liquid within the main body 110 from evaporating.

The cap 112 may be disposed on at least a portion of the main body 110. The cap 112 may facilitate access within the main body 110. More specifically, the cap 112 may allow (i.e., open) access within the main body 110 in response to moving (i.e., rotating) in a first direction (i.e. clockwise). Conversely, the cap 112 may prevent (i.e., close) access within the main body 110 in response to moving in a second direction (i.e., counterclockwise). For example, pest control, plant food, and/or nutrients may be poured into the main body 110 in response to removing the cap 112.

The liquid outlet 113 may be disposed on at least a portion of the main body 110. Moreover, the liquid outlet 113 may receive an external hose 20 thereon. The liquid outlet 113 may connect to a sprinkler system via the external hose 20, such that the at least one liquid from the main body 110 may be used to spray at least one plant and/or at least one lawn.

The primary hose 120 may include a filtration unit 121 therein, such as a sediment filter (e.g., separation by mesh), a carbon filter (e.g., granular activated carbon to remove unwanted taste and odor by absorbing contaminants), and a reverse osmosis unit (e.g., removing dissolved solids in liquid by forcing liquid through a semi-permeable membrane, which provides the purest tasting water), but is not limited thereto.

The primary hose 120 may be removably connected to at least a portion of the main body 110. The primary hose 120 may be flexible, such that the primary hose 120 may at least partially deform (i.e., bend, expand) in response to an application of force thereto. In other words, the primary hose 120 may be oriented in a variety of configurations based on an area where bending the primary hose 120 is necessary. Furthermore, the primary hose 120 may cleanse and/or filter the at least one liquid moving therethrough.

The connector hose 130 may be removably connected to at least a portion of an air conditioning unit 10 and/or the primary hose 120. The connector hose 130 may connect the air conditioning unit 10 to the primary hose 120. Moreover, the connector hose 130 may receive condensation formed from within the air conditioning unit 10 and a building connecting conduit 11. A power line 12 for the air conditioning unit 10 may share the building connecting conduit 11 to receive power from a building (e.g., a home). Also, the air conditioning unit 10 may include a refrigerant line 13 (e.g., a condenser, a fan, a refrigerant/coolant) to generate cool air therein. Accordingly, the connector hose 130 may transfer the condensation into the primary hose 120. Also, the primary hose 120 may direct the at least one liquid into the main body 110.

The pump 140 may include a switch 141, but is not limited thereto.

The pump 140 may be disposed within at least a portion of the main body 110 and connected to the liquid outlet 113. Additionally, the pump 140 may extract the at least one liquid from within the main body 110 and expel the at least one liquid through the liquid outlet 113.

Referring again to FIG. 1, the switch 141 is illustrated to be a switch. However, the switch 141 may be a button, a lever, a dial, a knob, and a crank, but is not limited thereto.

The switch 141 may be disposed on at least a portion of the main body 110. The switch 141 may turn on the pump 140 in response to moving to a first position. Conversely, the switch 141 may turn off the pump 140 in response to moving to a second position different from the first position.

The atmospheric water generator 150 may include an extraction hose 151, but is not limited thereto.

The atmospheric water generator 150 may be removably connected to the air conditioning unit and/or connected to the connector hose 130. The atmospheric water generator 150 may extract water from humidity in air. More specifically, the atmospheric water generator 150 may collect the humidity and/or the air around and/or within the air conditioning unit 10 to generate and/or divert water into the extraction hose 151. The extraction hose 151 may direct the water and/or the at least one liquid within the atmospheric water generator 150 into the connector hose 130.

The power source 160 may include a solar cell and a battery, but is not limited thereto.

The power source 160 may be disposed on and/or within at least a portion of the main body 110. Additionally, the power source 160 may be connected to the pump 140 and/or the atmospheric water generator 150. The power source 160 may provide power to the pump 140 and/or the atmospheric water generator 150.

Therefore, the liquid collection container 100 may allow water and/or the at least one liquid generated from the air conditioning unit 10 to be stored and/or used for additional purposes.

The present general inventive concept may include a liquid collection container 100 removably connected to an air conditioning unit 10, the liquid collection container 100 including a main body 110 to store at least one liquid therein, a primary hose 120 removably connected to at least a portion of the main body 110 to direct the at least one liquid condensed from the air conditioning unit 10 into the main body 110, and a pump 140 disposed within at least a portion of the main body 110 to extract the at least one liquid from within the main body 110 and expel the at least one liquid from the main body 110.

The primary hose 120 may include a filtration unit 121 to cleanse the at least one liquid moving therethrough.

The filtration unit 121 may be at least one of a sediment filter, a carbon filter, and a reverse osmosis unit.

The liquid collection container 100 may further include a connector hose 130 removably connected to at least a portion of the air conditioning unit 10 and the primary hose 120 to transfer condensation from the air conditioning unit 10 into the primary hose 120.

The liquid collection container 100 may further include an atmospheric water generator 150 removably connected to the air conditioning unit 10 to extract water from humidity in the air conditioning unit 10 and transfer the water to the primary hose 120.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A liquid collection container removably connected to an air conditioning unit, the liquid collection container comprising:
a main body to store at least one liquid therein;
a primary hose removably connected to at least a portion of the main body to direct the at least one liquid condensed from the air conditioning unit into the main body; and
a pump disposed within at least a portion of the main body to extract the at least one liquid from within the main body and expel the at least one liquid from the main body.

2. The liquid collection container of claim 1, wherein the primary hose comprises:
a filtration unit to cleanse the at least one liquid moving therethrough.

3. The liquid collection container of claim 2, wherein the filtration unit is at least one of a sediment filter, a carbon filter, and a reverse osmosis unit.

4. The liquid collection container of claim 1, further comprising:
a connector hose removably connected to at least a portion of the air conditioning unit and the primary hose to transfer condensation from the air conditioning unit into the primary hose.

5. The liquid collection container of claim 1, further comprising:
an atmospheric water generator removably connected to the air conditioning unit to extract water from humidity in the air conditioning unit and transfer the water to the primary hose.
